(19) United States
(12) Patent Application Publication
(10) Pub. No.: US 2011/0061799 A1
(43) Pub. Date: Mar. 17, 2011

(54) Miniaturized Lens Assembly and Method for Making the Same

(76) Inventor: Kun-Chih WANG, Taichung (TW)

(21) Appl. No.: 12/947,873

(22) Filed: Nov. 17, 2010

Related U.S. Application Data
(62) Division of application No. 11/439,117, filed on May 24, 2006.

(30) Foreign Application Priority Data
Jul. 6, 2005 (TW) 094122900

(51) Int. Cl. B32B 38/10; B32B 38/04; B32B 38/00; B29C 65/14

(52) U.S. Cl. 156/247

(57) ABSTRACT

A miniaturized lens assembly includes an image-capturing unit, a lens unit, and a binding layer. The image-capturing unit includes an image-capturing member. The lens unit includes an image-projecting portion for projecting an image along an optical axis to the image-capturing member. The binding layer extends around the optical axis, and binds the image-capturing unit to the lens unit. The binding layer includes a photosensitive polymeric material and spaces apart the lens unit and the image-capturing unit. A method for making the miniaturized lens assembly is also disclosed.

### CROSS-REFERENCE TO RELATED APPLICATION

This application is a divisional of U.S. patent application Ser. No. 11/439,117, filed on May 24, 2006.

This application claims priority of Taiwanese Application No. 094122900, filed on Jul. 6, 2005.

### BACKGROUND OF THE INVENTION

1. Field of the Invention

The invention relates to a lens assembly, more particularly to a miniaturized lens assembly. This invention also relates to a method for making the miniaturized lens assembly.

2. Description of the Related Art

Referring to FIG. 1, a conventional lens assembly is made by preparing optical lenses 901 and annular spacers 902 separately, and assembling the optical lenses 901 and the annular spacers 902 into a barrel 9 in sequence. However, when it is desired to apply the lens assembly to a camera phone, the lens assembly is required to be minimized in size. The aforesaid method cannot be used to make the miniaturized lens assembly applicable to camera phones in view of very high precision requirements thereof.

Referring to FIGS. 2 and 3, WO2004027880 discloses a camera device and a method for manufacturing the camera device. As shown in FIGS. 2 and 3, in one preferred embodiment of the method for manufacturing the camera device, a silicon wafer 1 having a plurality of image-capturing elements 101, a first micro-spacer wafer 2 having a plurality of first through holes 201, a first cover wafer 3 having a plurality of cover plates 301, a first lens substrate 4 having a plurality of first lenses 401, a second micro-spacer wafer 5 having a plurality of second through holes 501, a second lens substrate 6 having a plurality of second lenses 601, a third micro-spacer wafer (not shown), and a second cover wafer 7 are prepared, stacked, aligned with one another along main optical axes, and bonded to one another by using adhesive layers 8 to form a laminate. The laminate is sawn to obtain a plurality of camera devices, each of which includes one of the image-capturing elements 101, a first micro-spacer element 202 having the first through hole 201, the cover plate 301, the first lens 401, the second micro-spacer element 502 having the second through hole 501, the second lens 601, and the adhesive layers 8.

Although the method disclosed in WO2004027880 can make a plurality of camera devices at the same time, the following disadvantages are encountered:

1. The alignment of the wafers and substrates used for making the camera devices is carried out along the optical axes. Such an alignment is troublesome and difficult to control precisely. Moreover, since there is no aligning mark for sawing the laminate, it is difficult to saw the laminate precisely.

2. The adhesive layers 8 are required for bonding the wafers and substrates together. That is to say, in addition to the first micro-spacer element 202 and the second micro-spacer element 502, a plurality of the adhesive layers 8 are required in each of the camera devices to bond the aforesaid components together. The total thickness of the camera device is thus still relatively large. Furthermore, it is required to control the thickness of each of the adhesive layers 8 carefully to obtain a predetermined spacing between two adjacent components of the camera device.

### SUMMARY OF THE INVENTION

An object of the present invention is to provide a miniaturized lens assembly in which spacing and bonding of two adjacent components of the miniaturized lens assembly can be achieved simultaneously.

An other object of the present invention is to provide a method for making the miniaturized lens assembly.

Therefore, in one aspect of this invention, a miniaturized lens assembly includes an image-capturing unit, a lens unit, and a binding layer. The image-capturing unit includes an image-capturing member. The lens unit includes an image-projecting portion for projecting an image along an optical axis to the image-capturing member. The binding layer extends around the optical axis, and binds the image-capturing unit to the lens unit. The binding layer includes a photosensitive polymeric material and spaces apart the lens unit and the image-capturing unit.

In another aspect of this invention, a method for making the miniaturized lens assembly includes the steps of:

a) preparing an imaging substrate including a plurality of image-capturing members, and a lens substrate including a plurality of image-projecting portions that correspond respectively to the image-capturing members;

b) applying a photosensitive polymeric material to the lens substrate;

c) irradiating and developing the photosensitive polymeric material to form a binding layer having a plurality of through holes aligned respectively with the image-projecting portions on the lens substrate;

d) aligning the image-projecting portions of the lens substrate with the image-capturing members of the imaging substrate, and stacking the lens substrate and the imaging substrate together such that the binding layer is disposed between the lens substrate and the imaging substrate;

e) bonding the lens substrate to the imaging substrate by pressing the lens substrate and the binding layer against the imaging substrate while curing the binding layer by heating; and

f) separating the image-projecting portions from the lens substrate and separating the image-capturing members from the imaging substrate by cutting the lens substrate and the imaging substrate.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional lens assembly;

FIG. 2 is a schematic view illustrating a method for manufacturing a conventional camera device disclosed in WO2004027880;

FIG. 3 is a partly sectional view of the conventional camera device disclosed in WO2004027880;

FIG. 4 is a sectional view of the preferred embodiment of a miniaturized lens assembly according to this invention mounted on a circuit board; and

FIGS. 5-13 are views to illustrate consecutive steps of the preferred embodiment of a method for making the miniaturized lens assembly of FIG. 4.

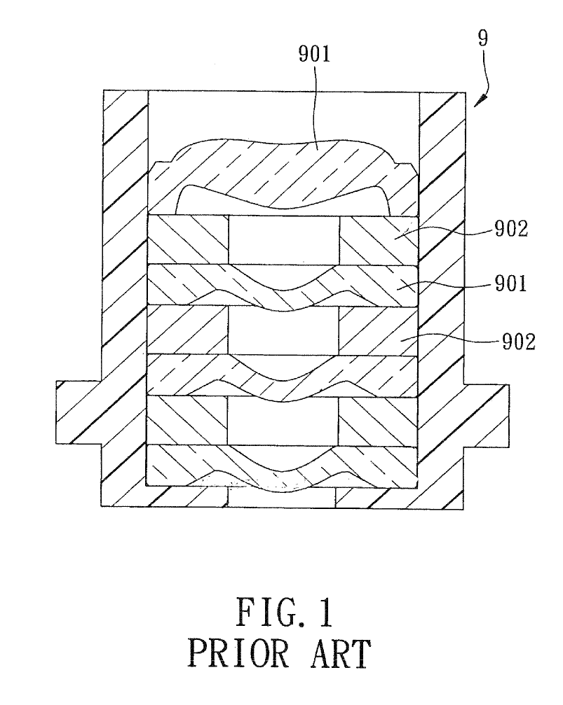

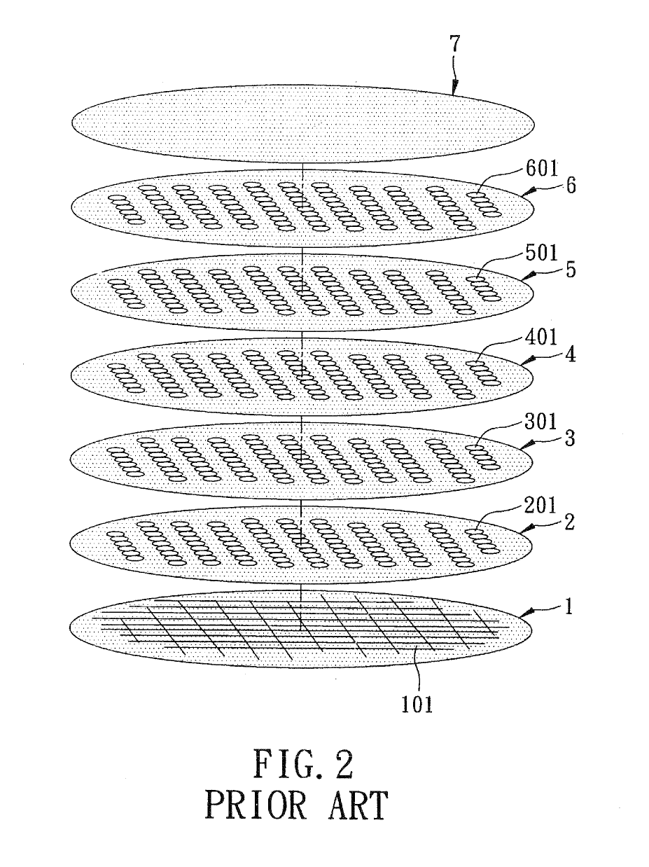

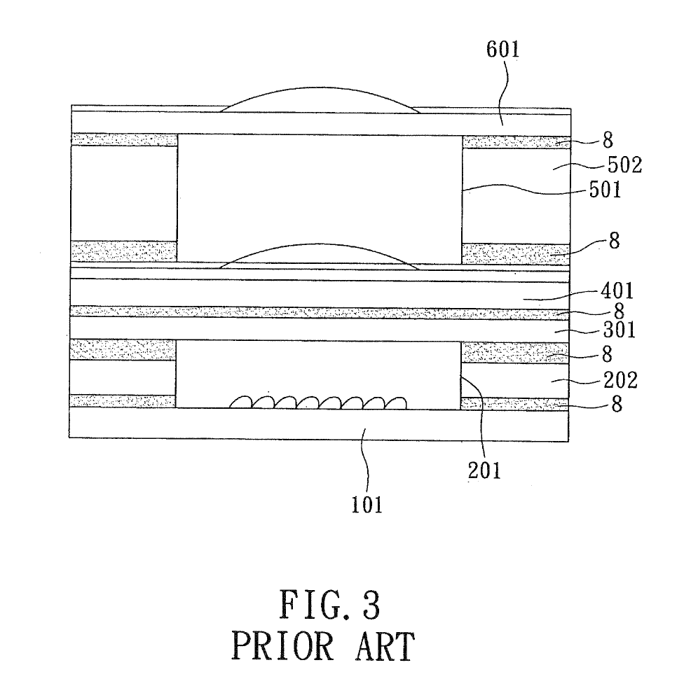

### DETAILED DESCRIPTION OF THE PREFERRED EMBODIMENT

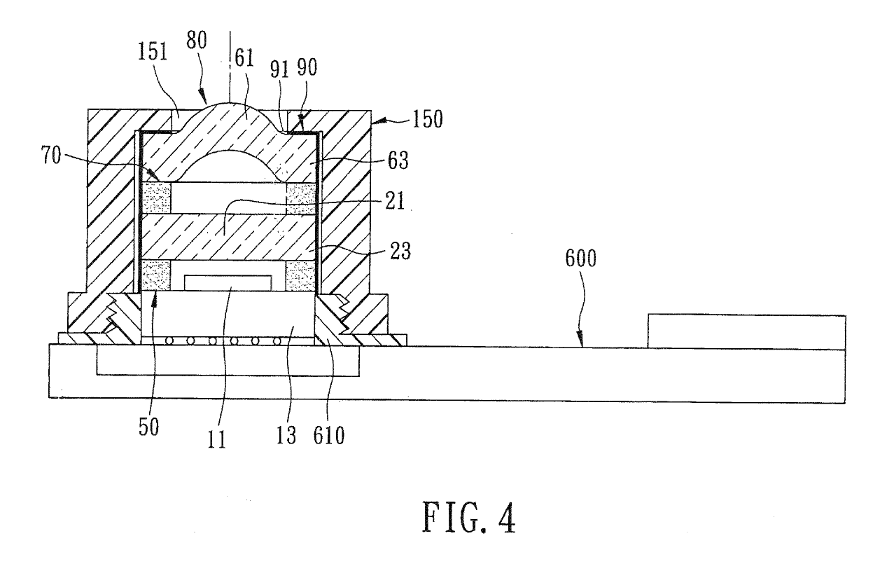

Referring to FIG. 4, the preferred embodiment of the miniaturized lens assembly 80 according to this invention includes an image-capturing unit 13, a first lens unit 23, a first binding layer 50, a second lens unit 63, a second binding layer 70, a light-shielding member 90, and a barrel 150.

The image-capturing unit 13 includes an image-capturing member 11.

The first lens unit 23 includes a first image-projecting portion 21 for projecting an image along an optical axis to the image-capturing member 11.

The first binding layer 50 extends annularly around the optical axis, and binds the image-capturing unit 13 to the first lens unit 23. The first binding layer 50 includes a photosensitive polymeric material, and has a spacing thickness to space apart the first lens unit 23 and the image-capturing unit 13. In this preferred embodiment, the photosensitive polymeric material is a photoresist.

The second lens unit 63 includes a second image-projecting portion 61 for projecting the image along the optical axis to the image-capturing member 11 through the first image-projecting portion 21.

The second binding layer 70 extends annularly around the optical axis, and binds the second lens unit 63 to the first lens unit 23. The second binding layer 70 includes the photosensitive polymeric material and has a spacing thickness to space apart the first and second lens units 23,63. In this preferred embodiment, the photosensitive polymeric material is a photoresist.

The light-shielding member 90 surrounds the first binding layer 50, the first lens unit 23, the second binding layer 70, and the second lens unit 63, is coaxial with the optical axis, and has an opening 91 to permit projection of light onto the second image-projecting portion 61 of the second lens unit 63 and the first image-projecting portion 21 of the first lens unit 23.

The barrel 150 receives the image-capturing unit 13, the first binding layer 50, the first lens unit 23, the second binding layer 70, the second lens unit 63, and the light-shielding member 90. The barrel 150 has an opening 151 proximate to and aligned with the opening 91 of the light-shielding member 90 to permit projection of light onto the second image-projecting portion 61 of the second lens unit 63 and the first image-projecting portion 21 of the first lens unit 23.

The preferred embodiment of the method for making the miniaturized lens assembly 80 according to this invention includes the steps of:

A) Preparing an Imaging Substrate and a First Lens Substrate:

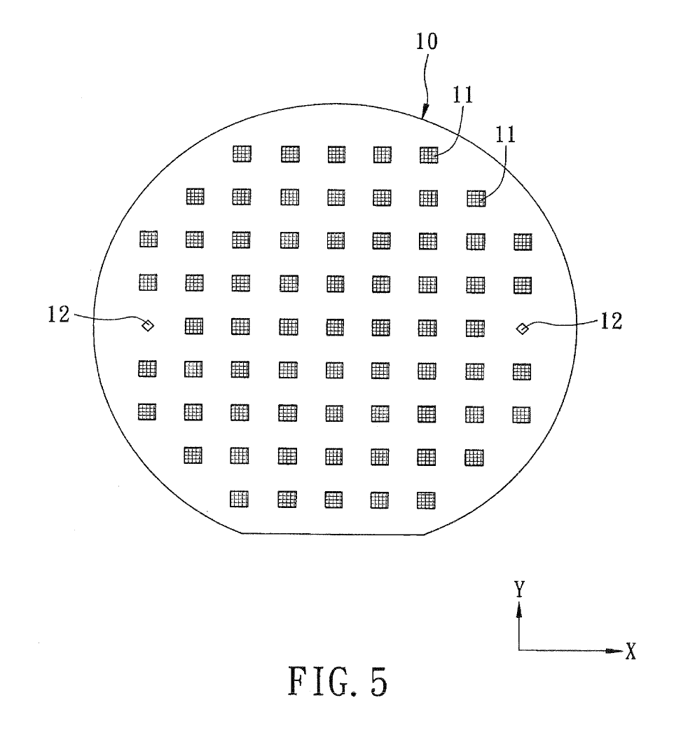

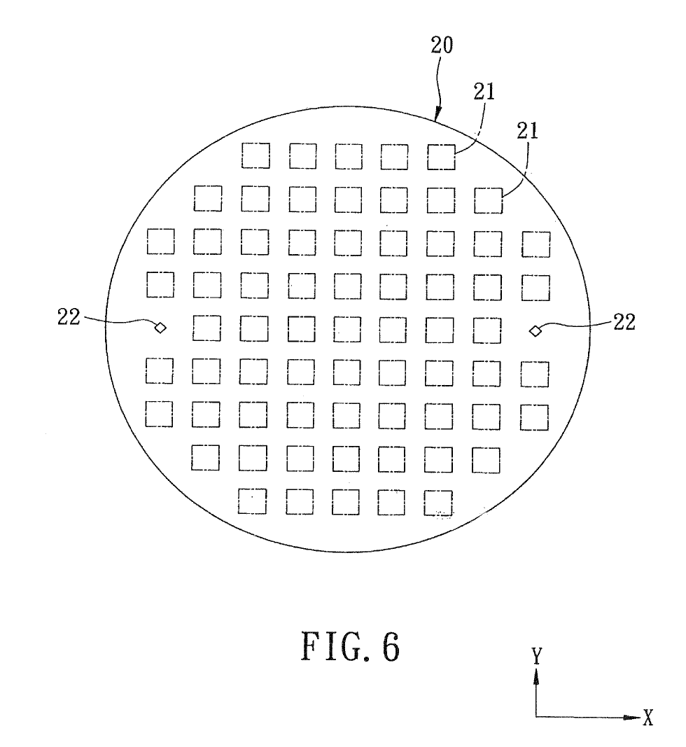

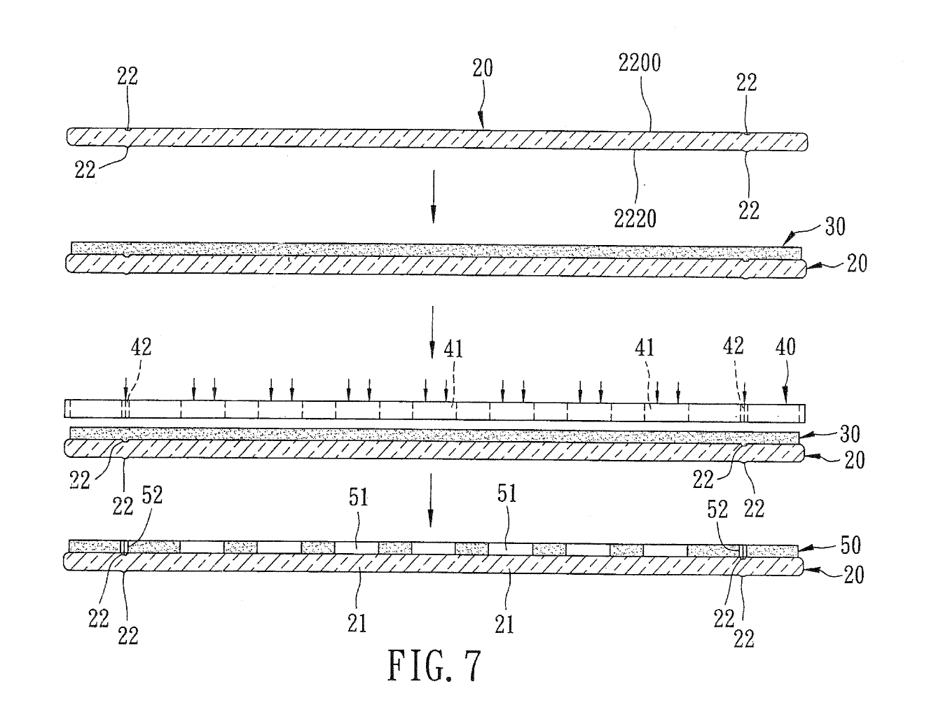

Referring to FIGS. 5 and 6, an imaging substrate 10 and a first lens substrate 20 are prepared. The imaging substrate 10 includes a plurality of image-capturing members 11 which are arranged in rows and columns along two intersecting cutting directions (X, Y). The imaging substrate 10 is provided with two aligning marks 12 spaced apart from each other along one of the two cutting directions (X). The first lens substrate 20 includes a plurality of first image-projecting portions 21 that correspond respectively to the image-capturing members 11. The first lens substrate 20 is provided with four first aligning marks 22. Two of the first aligning marks 22 are formed on a top surface 2200 (see FIG. 7) of the first lens substrate 20. The other two of the first aligning marks 22 are formed on a bottom surface 2220 of the first lens substrate 20, and are aligned with the first aligning marks 22 on the top surface 2200 of the first lens substrate 20 and with the aligning marks 12 of the imaging substrate 10, respectively. In this preferred embodiment, each of the image-capturing members 11 is a charge coupled device or a complementary metal-oxide semiconductor. The first lens substrate 20 is an infra-red filter in this embodiment.

B) Applying a Photosensitive Polymeric Material:

Referring to FIG. 7, a photosensitive polymeric material 30 is applied to the first lens substrate 20. In this preferred embodiment, the photosensitive polymeric material 30 is a positive photoresist, such as AZ4210 and AZ1500 series of photoresist manufactured by AZ Electronic Materials, or a negative photoresist, such as a photosensitive BCE photoresist manufactured by Dow Chemical.

C) Soft Baking:

The first lens substrate 20 together with the photosensitive polymeric material 30 is soft baked by heating at a temperature ranging from 60 to 90° C. to remove a solvent contained in the photosensitive polymeric material 30.

D) Irradiating and Developing:

The photosensitive polymeric material 30 is irradiated through a photo mask 40, which includes a plurality of through holes 41 aligned with the first image-projecting portions 21 of the first lens substrate 20 correspondingly, and two aligning holes 42 aligned with the first aligning marks 22 of the first lens substrate 20 correspondingly. In this preferred embodiment, the photosensitive polymeric material 30 is a positive photoresist. If a negative photoresist is used, the photo mask 40 should be changed with a photo mask having a pattern reverse to that of the photo mask 40.

Subsequently, the photosensitive polymeric material 30 is developed using a developing agent to dissolve the irradiated portions of the photosensitive polymeric material 30 to form a first binding layer 50, which has a plurality of first through holes 51 aligned respectively with the first image-projecting portions 21 on the first lens substrate 20, and two first aligning holes 52 aligned with the first aligning marks 22 of the first lens substrate 20 correspondingly.

E) Aligning and Stacking:

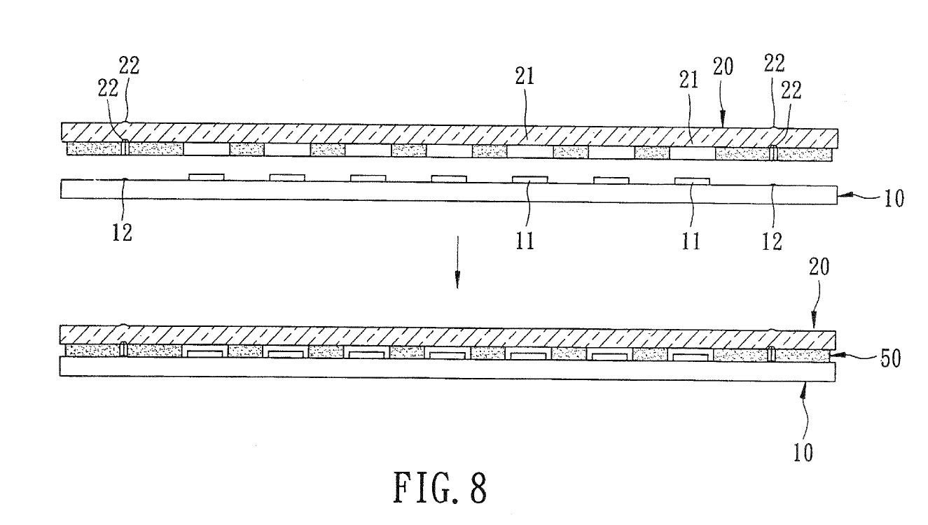

Referring to FIG. 8, the first image-projecting portions 21 of the first lens substrate 20 are aligned with the image-capturing members 11 of the imaging substrate 10 by aligning the first aligning marks 22 of the first lens substrate 20 with the aligning marks 12 of the imaging substrate 10 correspondingly. The first lens substrate 20 and the imaging substrate 10 are stacked together such that the first binding layer 50 is disposed between the first lens substrate 20 and the imaging substrate 10.

F) Bonding:

The first lens substrate 20 is bonded to the imaging substrate 10 by pressing the first lens substrate 20 and the first binding layer 50 against the imaging substrate 10 while curing the first binding layer 50 under vacuum by heating at a temperature ranging from 90 to 300° C.

G) Preparing a Second Lens Substrate:

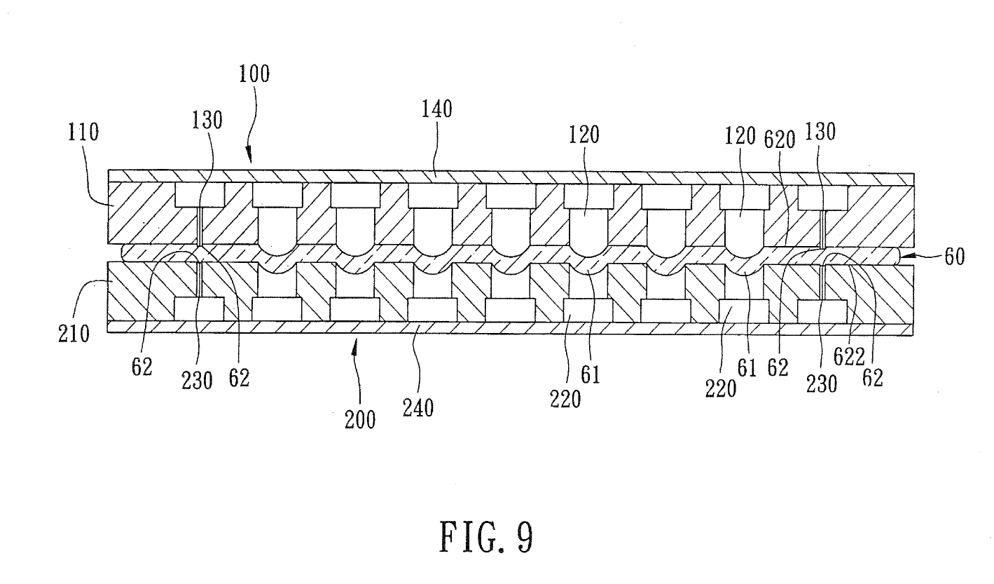

Referring to FIG. 9, a second lens substrate 60 is prepared, which includes a plurality of second image-projecting portions 61 that correspond respectively to the image-capturing members 11 of the imaging substrate 10. The second lens substrate 60 further includes four second aligning marks 62. Two of the second aligning marks 62 are formed on a top surface 620 of the second lens substrate 60. The other two of the second aligning marks 62 are formed on a bottom surface 622 of the second lens substrate 60, and are aligned with the second aligning marks 62 on the top surface 620 of the second lens substrate 20 and with the first aligning marks 22 of the first lens substrate 20, respectively. The second lens substrate 60 is made using an upper mold unit 100 and a lower mold unit 200. The upper mold unit 100 includes an upper mold plate 110, an array of upper mold cores 120 mounted in the upper mold plate 110 along the cutting directions (X, Y) two upper mark molding cores 130 mounted in the upper mold plate 110 along one of the cutting directions (X), and an upper fixing plate 140 stacked on the upper mold plate 110. The lower mold unit 200 includes a lower mold plate 210, an array of lower mold cores 220 mounted in the lower mold plate 210 and corresponding to the upper mold cores 120, two lower mark molding cores 230 mounted in the lower mold plate 210 and corresponding to the upper mark molding cores 130, and a lower fixing plate 240 stacked below the lower mold plate 210.

H) Forming a Second Binding Layer:

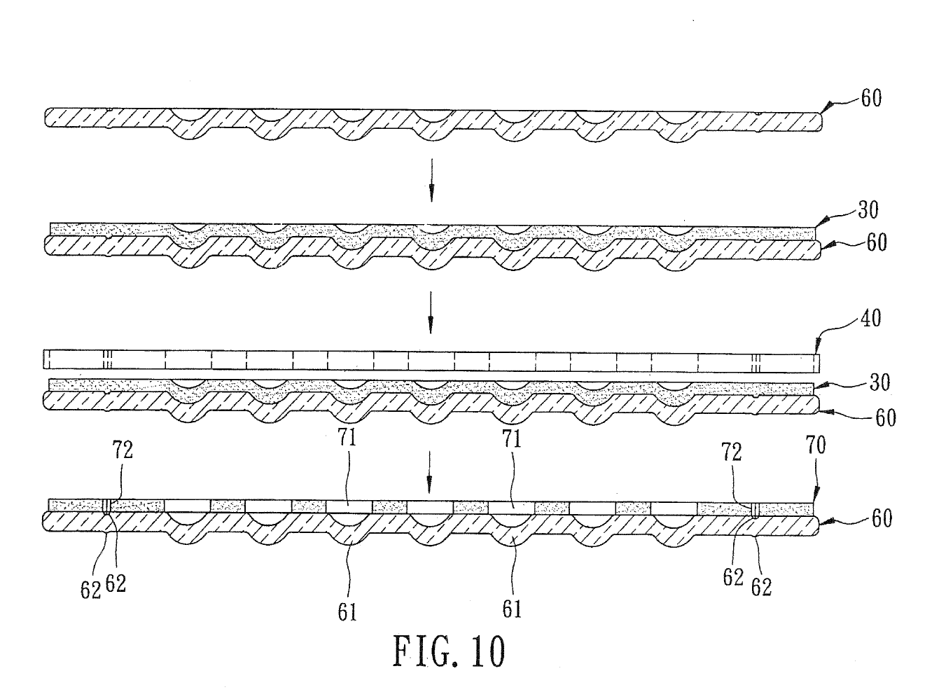

Referring to FIG. 10, the steps similar to the aforesaid steps B), C), and D) are conducted to form a second binding layer 70 on the second lens substrate 60. The second binding layer 70 has a plurality of second through holes 71 aligned with the second image-projecting portions 61 on the second lens substrate 60, respectively, and two second aligning holes 72 aligned with the second aligning marks 62 of the second lens substrate 20 correspondingly.

I) Aligning and Stacking:

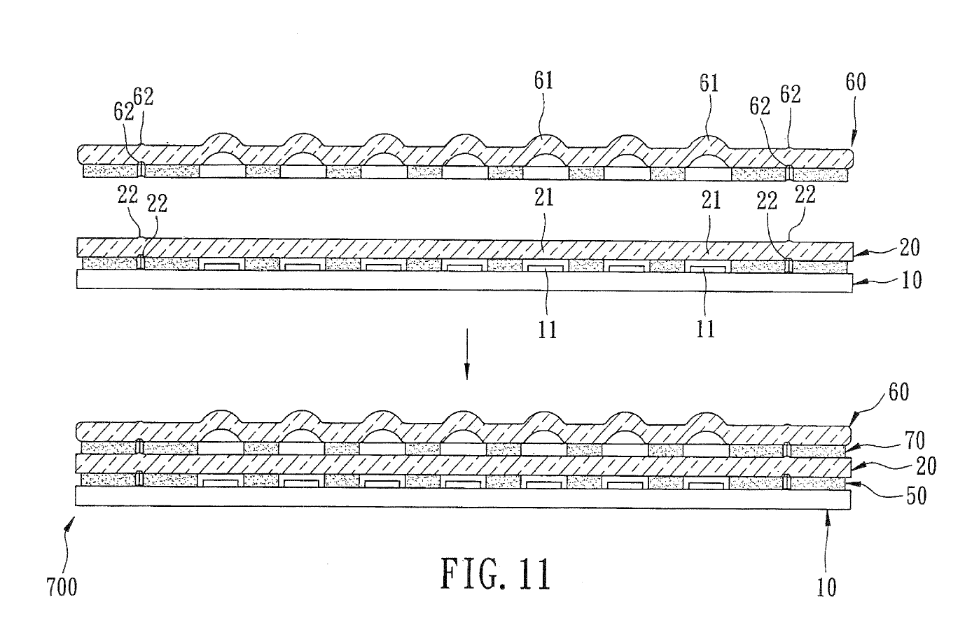

Referring to FIG. 11, the second image-projecting portions 61 of the second lens substrate 60 are aligned with the first image-projecting portions 21 of the first lens substrate 20 and the image-capturing members 11 of the imaging substrate 10 by aligning the second aligning marks 62 of the second lens substrate 60 with the first aligning marks 22 of the first lens substrate 20 correspondingly. The second lens substrate 60 is stacked on the first lens substrate 20 bonded to the imaging substrate 10 such that the second binding layer 70 is disposed between the first lens substrate 20 and the second lens substrate 60.

J) Bonding:

The second lens substrate 60 is bonded to the first lens substrate 20 via the second binding layer 70 using a bonding step similar to the aforesaid step F). Therefore, a laminate 700 is obtained, which includes the imaging substrate 10, the first binding layer 50, the first lens substrate 20, the second binding layer 70, and the second lens substrate 60 in sequence.

K) Cutting:

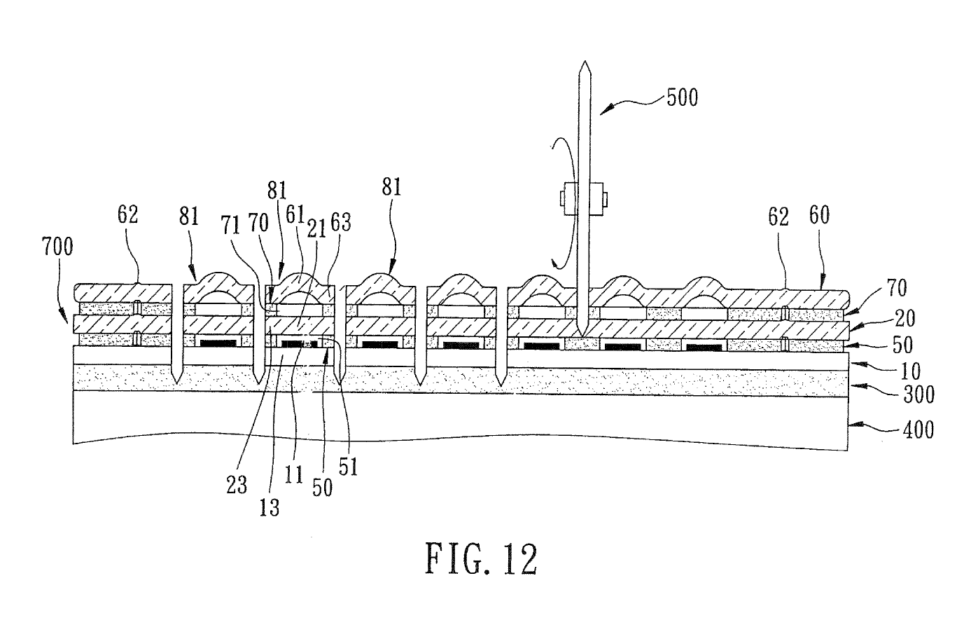

Referring to FIG. 12, the laminate 700 is fixed on a work table 400 of a cutting machine (not shown) using a UV tape 300. The second aligning marks 62 of the second lens substrate 20 are aligned with reference aligning marks by adjusting the work table 400. The laminate 700 is cut by a cutting tool 500 along the cutting directions (X, Y) so as to separate the second image-projecting portions 61 from the second lens substrate 60, to separate the first image-projecting portions 21 from the first lens substrate 20, and to separate the image-capturing members 11 from the imaging substrate 10. Therefore, a plurality of semi-products 81 are obtained accordingly. Each of the semi-products includes the image-capturing unit 13 having the image-capturing member 11, the first binding layer 50 having the first through hole 51, the first lens unit 23 having the first image-projecting portion 21, the second binding layer 70 having the second through hole 71, and the second lens unit 63 having the second image-projecting portion 61. The semi-products 81 can be removed from the work table 400 by exposing the UV-tape 300 to a UV-light.

L) Covering Each Semi-Product:

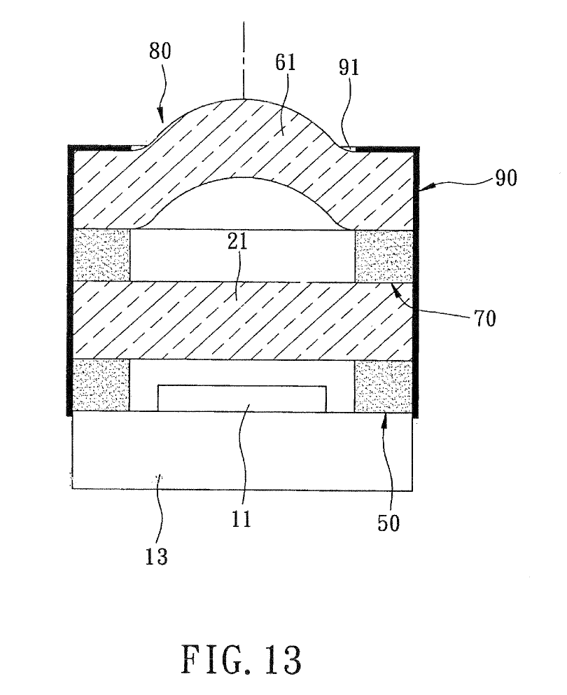

Referring to FIG. 13, a light-shielding member 90 is provided to cover each of the semi-products 81 so as to avoid reflection of light. In this preferred embodiment, the light-shielding member 90 is made of ink.

M) Disposing Each of the Semi-Products in a Corresponding Barrel:

Referring again to FIG. 4, each of the semi-products 81 covered with the light-shielding member 90 is disposed in a corresponding barrel 150 so as to obtain the miniaturized lens assembly 80, which can be fastened on a base seat 610 of a circuit board 600 by screwing.

It should be noted that, according to specific optical requirements, a plurality of the second lens substrates 60 can be stacked on the first lens substrate 20 so that the miniaturized lens assembly 80 includes a plurality of the second lens units 63.

In view of the aforesaid, the miniaturized lens assembly 80 of this invention has the following advantages:

1) A plurality of the miniaturized lens assemblies 80 can be made at the same time. The manufacture of the miniaturized lens assembly 80 is relatively simple. Therefore, the productivity is increased significantly, and the production cost is reduced.

2) Since the imaging substrate 10, the first lens substrate 20, and the second lens substrate 60 are provided with the aligning marks 12, the first aligning marks 22, and the second first aligning marks 62, the stacking and cutting steps can be carried out simply and precisely.

3) In addition to acting as a binder for binding the imaging substrate 10, the first lens substrate 20, and the second lens substrate 60 together, the first binding layer 50 and the second binding layer 70 also act as spacers to space the imaging substrate 10 apart from the first lens substrate 20 and to space the first lens substrate 20 apart from the second lens substrate 60. Therefore, the overall thickness of the miniaturized lens assembly 80 of this invention can be controlled relatively easily and can be reduced as compared to the aforesaid prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for making a miniaturized lens assembly, comprising the steps of:
a) preparing an imaging substrate including a plurality of image-capturing members, and a first lens substrate including a plurality of first image-projecting portions that correspond respectively to the image-capturing members;
b) applying a photosensitive polymeric material to the first lens substrate;
c) irradiating and developing the photosensitive polymeric material to form a first binding layer having a plurality of first through holes aligned respectively with the first image-projecting portions on the first lens substrate;
d) aligning the first image-projecting portions of the first lens substrate with the image-capturing members of the imaging substrate, and stacking the first lens substrate and the imaging substrate together such that the first binding layer is disposed between the first lens substrate and the imaging substrate;
e) bonding the first lens substrate to the imaging substrate by pressing the first lens substrate and the first binding layer against the imaging substrate while curing the first binding layer by heating; and
f) separating the first image-projecting portions from the first lens substrate and separating the image-capturing members from the imaging substrate by cutting the first lens substrate and the imaging substrate.

2. The method as claimed in claim 1, wherein, in step a), the image-capturing members are arranged in rows and columns along two intersecting cutting directions, the imaging substrate being provided with two aligning marks spaced apart from each other along one of the two cutting directions, the first lens substrate being provided with at least two first aligning marks.

3. The method as claimed in claim 2, wherein, in step c), irradiating and developing the photosensitive polymeric material results in two aligning holes in the first binding layer that are aligned with the first aligning marks of the first lens substrate, respectively.

4. The method as claimed in claim 3, wherein step d) includes aligning the first aligning marks of the first lens substrate with the aligning marks of the imaging substrate, respectively, and wherein, in step f), the first lens substrate and the imaging substrate are cut along the two cutting directions.

5. The method as claimed in claim 1, further comprising a step of removing a solvent contained in the photosensitive polymeric material by heating prior to step c).

6. The method as claimed in claim 5, wherein removal of the solvent is conducted at a temperature ranging from 60 to 90° C.

7. The method as claimed in claim 1, wherein the heating is conducted at a temperature ranging from 90 to 300° C. in step e).

8. The method as claimed in claim 1, wherein, after step e), the method further comprises the steps of:
g) preparing a second lens substrate including a plurality of second image-projecting portions that correspond respectively to the image-capturing members of the imaging substrate;
h) applying a photosensitive polymeric material to the second lens substrate;
i) irradiating and developing the photosensitive polymeric material on the second lens substrate to form a second binding layer having a plurality of second through holes aligned with the second image-projecting portions on the second lens substrate, respectively;
j) aligning the second image-projecting portions of the second lens substrate with the first image-projecting portions of the first lens substrate and the image-capturing members of the imaging substrate;
k) stacking the second lens substrate on the first lens substrate bonded to the imaging substrate such that the second binding layer is disposed between the first lens substrate and the second lens substrate; and
l) bonding the second lens substrate to the first lens substrate via the second binding layer.

9. The method as claimed in claim 8, wherein, in step f), the second lens substrate is also cut while the first lens substrate and the imaging substrate are cut, thus resulting in a plurality of semi-products after step f).

10. The method as claimed in claim 9, further comprising a step of providing a light-shielding member to cover each of the semi-product.

11. The method as claimed in claim 10, further comprising a step of disposing each of the semi-products in a corresponding barrel.
